(19) United States
(12) Patent Application Publication
(10) Pub. No.: US 2023/0371018 A1
(43) Pub. Date: Nov. 16, 2023

(54) MULTIPLE USER SUBSCRIBER IDENTITY MODULE GAP PATTERN MODIFICATION

(71) Applicant: QUALCOMM Incorporated, San Diego, CA (US)

(72) Inventors: Ozcan OZTURK, San Diego, CA (US); Reza SHAHIDI, La Jolla, CA (US); Arvind Vardarajan SANTHANAM, San Diego, CA (US)

(21) Appl. No.: 18/308,340

(22) Filed: Apr. 27, 2023

Related U.S. Application Data
(60) Provisional application No. 63/364,776, filed on May 16, 2022.

(51) Int. Cl. H04W 72/12

(52) U.S. Cl. CPC H04W 72/1215; H04W 88/06

(57) ABSTRACT

Various aspects of the present disclosure generally relate to wireless communication. In some aspects, a user equipment (UE) may obtain a configuration associated with a first universal subscriber identity module (USIM) and a configuration associated with a second USIM. The UE may transmit a request for a gap pattern associated with the first USIM or the second USIM. The UE may receive an indication of the gap pattern. The UE may selectively communicate or measure according to the gap pattern. Numerous other aspects are described.

### CROSS-REFERENCE TO RELATED APPLICATION

This Patent application claims priority to U.S. Provisional Patent Application No. 63/364,776, filed on May 16, 2022, entitled “MULTIPLE USER SUBSCRIBER IDENTITY MODULE GAP PATTERN MODIFICATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for multiple user subscriber identity module gap pattern modification.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining a configuration associated with a first universal subscriber identity module (USIM) and a configuration associated with a second USIM. The method may include transmitting a request for a gap pattern associated with the first USIM or the second USIM. The method may include receiving an indication of the gap pattern. The method may include selectively communicating or measuring according to the gap pattern.

Some aspects described herein relate to a method of wireless communication performed by a network node. The method may include transmitting, to a UE, a configuration associated with a first USIM and a configuration associated with a second USIM. The method may include receiving, from the UE, a request for a gap pattern associated with the first USIM or the second USIM. The method may include transmitting, to the UE, an indication of the gap pattern.

Some aspects described herein relate to an apparatus for wireless communication performed by a UE. The apparatus may include a memory and one or more processors, coupled to the memory. The one or more processors may be configured to obtain a configuration associated with a first USIM and a configuration associated with a second USIM. The one or more processors may be configured to transmit a request for a gap pattern associated with the first USIM or the second USIM. The one or more processors may be configured to receive an indication of the gap pattern. The one or more processors may be configured to selectively communicate or measure according to the gap pattern.

Some aspects described herein relate to an apparatus for wireless communication performed by a network node. The apparatus may include a memory and one or more processors, coupled to the memory. The one or more processors may be configured to transmit, to a UE, a configuration associated with a first USIM and a configuration associated with a second USIM. The one or more processors may be configured to receive, from the UE, a request for a gap pattern associated with the first USIM or the second USIM. The one or more processors may be configured to transmitting, to the UE, an indication of the gap pattern.

Some aspects described herein relate to a non-transitory computer-readable medium that stores a set of instructions for wireless communication by a UE. The set of instructions, when executed by one or more processors of the UE, may cause the UE to obtain a configuration associated with a first USIM and a configuration associated with a second USIM. The set of instructions, when executed by one or more processors of the UE, may cause the UE to transmit a request for a gap pattern associated with the first USIM or the second USIM. The set of instructions, when executed by one or more processors of the UE, may cause the UE to receive an indication of the gap pattern. The set of instructions, when executed by one or more processors of the UE, may cause the UE to selectively communicate or measure according to the gap pattern.

Some aspects described herein relate to a non-transitory computer-readable medium that stores a set of instructions for wireless communication by a network node. The set of instructions, when executed by one or more processors of the network node, may cause the network node to transmit, to a UE, a configuration associated with a first USIM and a configuration associated with a second USIM. The set of instructions, when executed by one or more processors of the network node, may cause the network node to receive, from the UE, a request for a gap pattern associated with the first USIM or the second USIM. The set of instructions, when executed by one or more processors of the network node, may cause the network node to transmit, to the UE, an indication of the gap pattern.

Some aspects described herein relate to an apparatus for wireless communication. The apparatus may include means for obtaining a configuration associated with a first USIM and a configuration associated with a second USIM. The apparatus may include means for transmitting a request for a gap pattern associated with the first USIM or the second USIM. The apparatus may include means for receiving an indication of the gap pattern. The apparatus may include means for selectively communicating or measuring according to the gap pattern.

Some aspects described herein relate to an apparatus for wireless communication. The apparatus may include means for transmitting, to a UE, a configuration associated with a first USIM and a configuration associated with a second USIM. The apparatus may include means for receiving, from the UE, a request for a gap pattern associated with the first USIM or the second USIM. The apparatus may include means for transmitting, to the UE, an indication of the gap pattern.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of multiple user subscriber identity module (MUSIM) communications.

FIG. 6 is a diagram illustrating an example associated with MUSIM gap pattern modification, in accordance with the present disclosure.

FIG. 7 is a diagram illustrating an example process associated with MUSIM gap pattern modification, in accordance with the present disclosure.

FIG. 8 is a diagram illustrating an example process associated with MUSIM gap pattern modification, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

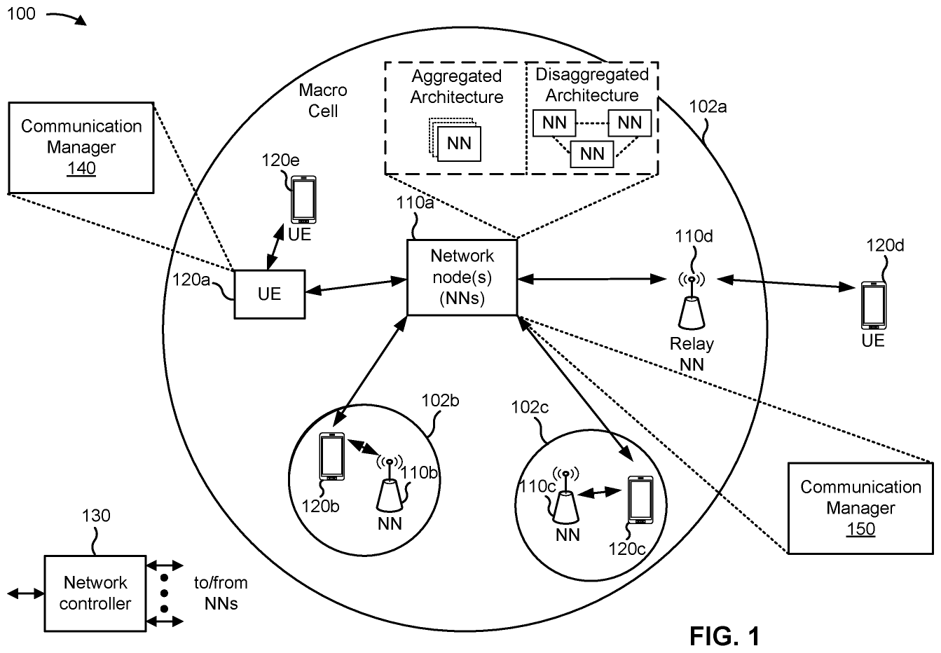

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain a configuration associated with a first universal subscriber identity module (USIM) and a configuration associated with a second USIM; transmit a request for a gap pattern associated with the first USIM or the second USIM; receive an indication of the gap pattern; and selectively communicate or measure according to the gap pattern. Additionally, or alternatively, the communication manager 140 may perform one or more other operations described herein.

In some aspects, the network node 110 may include a communication manager 150. As described in more detail elsewhere herein, the communication manager 150 may transmit, to the UE, a configuration associated with a first USIM and a configuration associated with a second USIM; receive, from the UE, a request for a gap pattern associated with the first USIM or the second USIM; and transmit, to the UE, an indication of the gap pattern. Additionally, or alternatively, the communication manager 150 may perform one or more other operations described herein.

As indicated above, FIG. 1 is provided as an example. Other examples may differ from what is described with regard to FIG. 1.

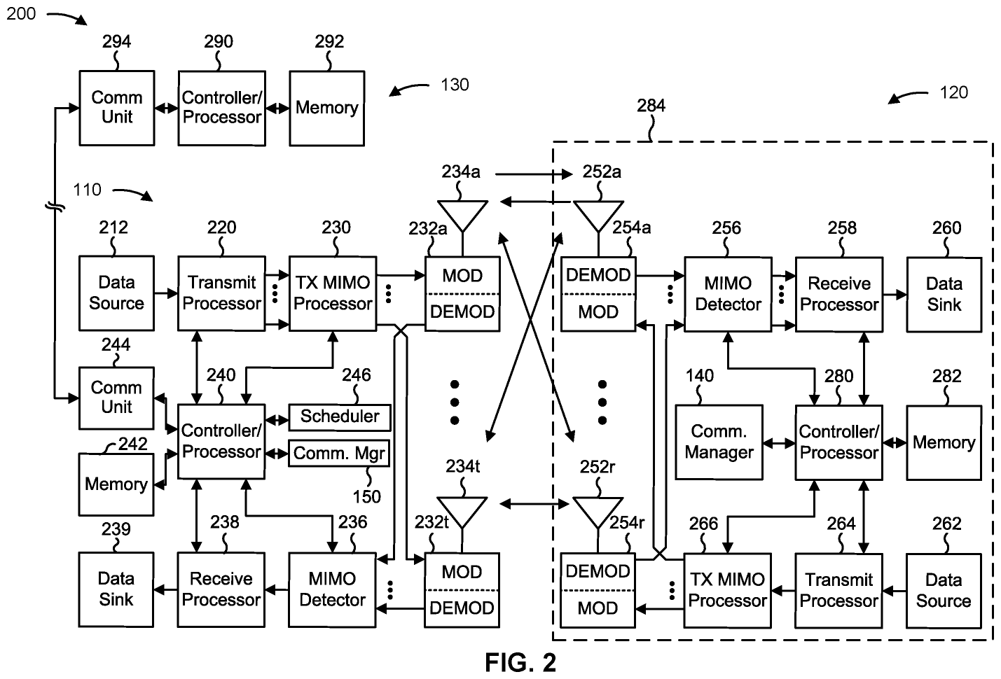

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

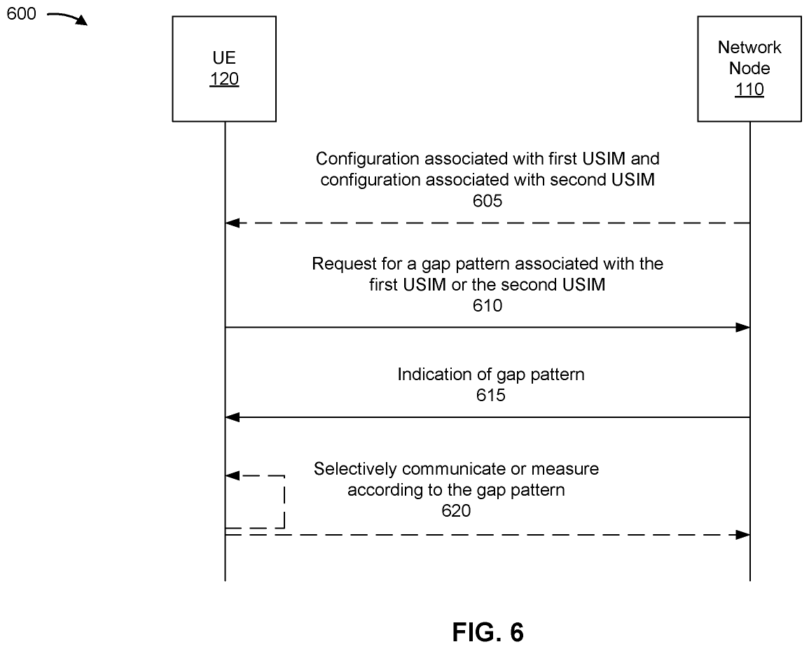

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

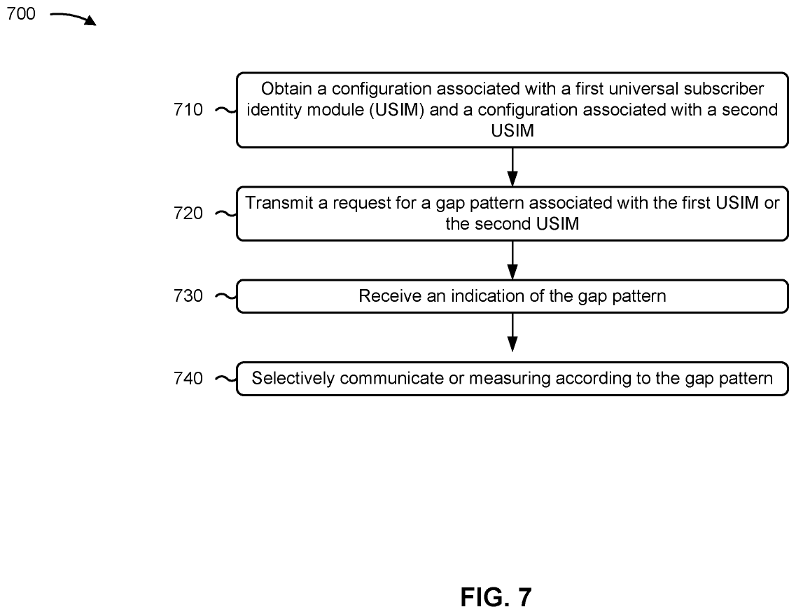

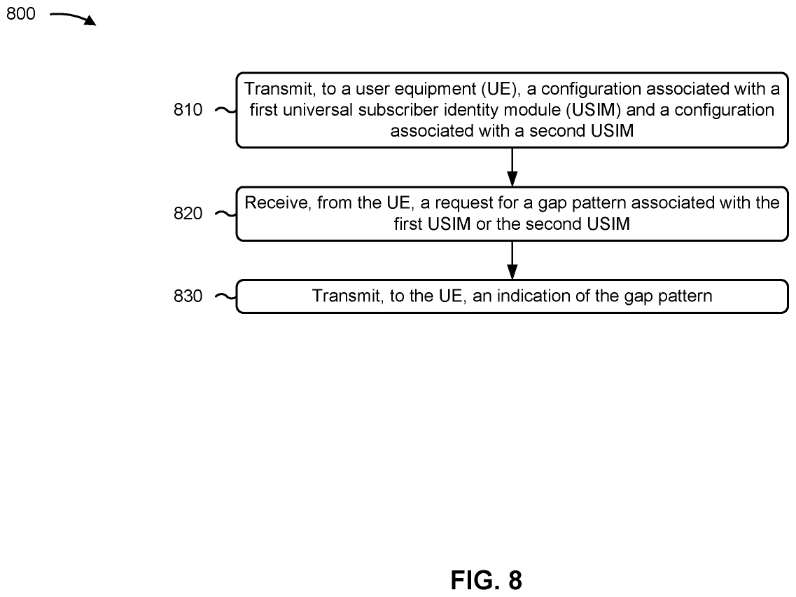

The controller/processor 240 of the network node 110, the controller/processor 280 of the UE 120, and/or any other component(s) of FIG. 2 may perform one or more techniques associated with MUSIM gap pattern modification, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for obtaining a configuration associated with a first USIM and a configuration associated with a second USIM; means for transmitting a request for a gap pattern associated with the first USIM or the second USIM; means for receiving an indication of the gap pattern; and/or means for selectively communicating or measuring according to the gap pattern. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to the UE, a configuration associated with a first USIM and a configuration associated with a second USIM; means for receiving, from the UE, a request for a gap pattern associated with the first USIM or the second USIM; and/or means for transmitting, to the UE, an indication of the gap pattern. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

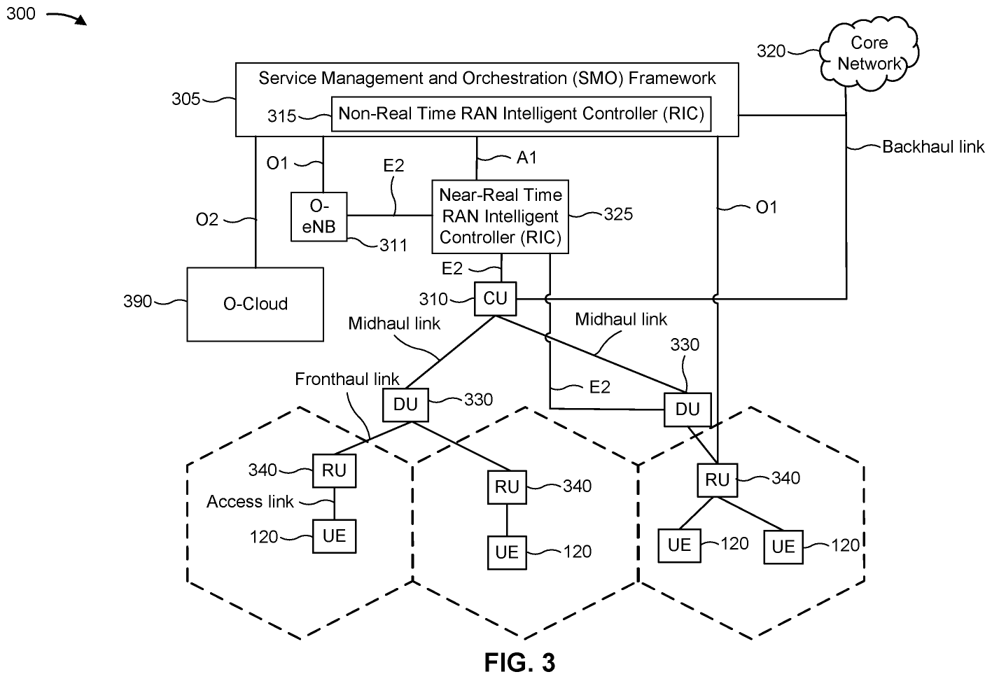

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

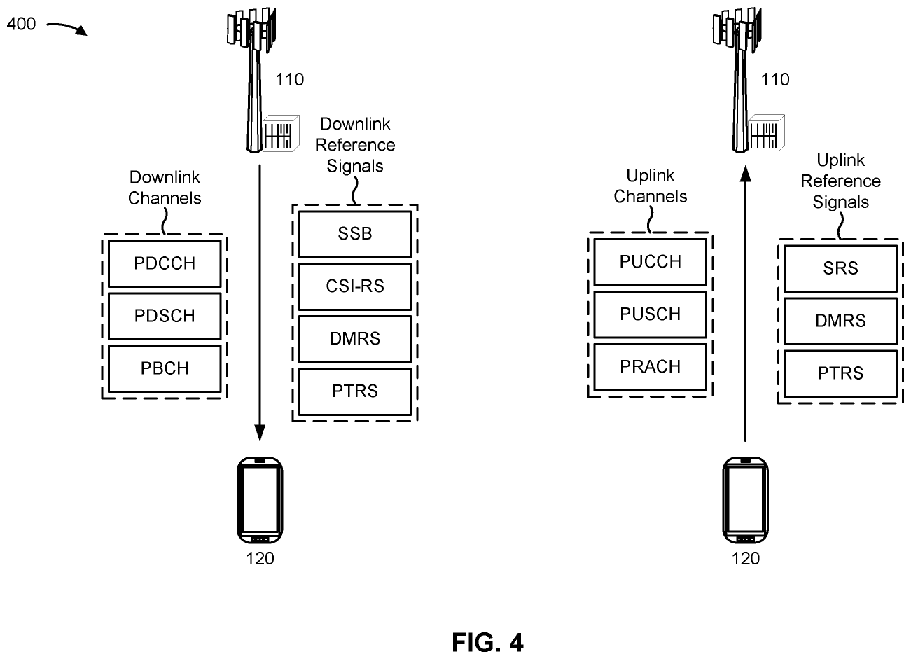

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

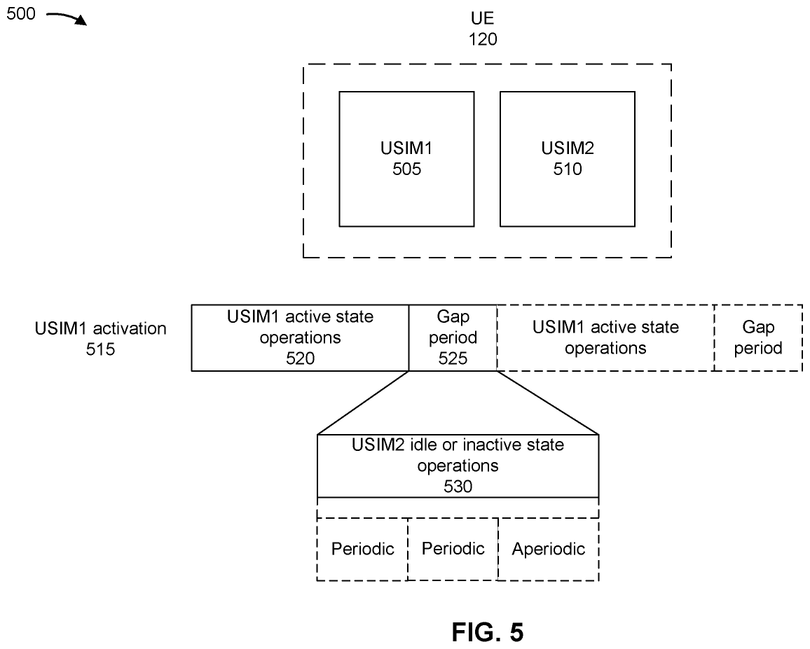

FIG. 5 is a diagram illustrating an example of multiple USIM (MUSIM) communications, in accordance with the present disclosure. In some cases, the UE 120 may be configured with multiple USIMs. For example, the UE 120 may be configured with a first USIM (USIM1 505) and a second USIM (USIM2 510). In some cases, the USIM1 505 may be associated with a first service provider or a first set of functionalities for the UE 120, and the USIM2 510 may be associated with a second service provider or a second set of functionalities for the UE 120. For example, the UE 120 may use the USIM1 505 for communications using the first service provider or for performing the first set of functionalities, and may use the USIM2 510 for communications using the second service provider or for performing the second set of functionalities.

As shown by reference number 515, the UE 120 may activate the USIM1 505. Thus, the USIM1 505 may be considered to be in an active state. Conversely, the USIM2 510 may be considered to be in an idle state or an inactive state. In some cases, only one USIM of the MUSIM configuration may be in an active state at a given time. In some cases, the UE 120 may be configured to perform one or more active state operations 520 associated with the USIM1 505 while the USIM1 505 is in the active state. For example, the UE 120 may be configured to transmit information or data to, and to receive information or data from, the network node 110 using the USIM1 505 while the USIM1 505 is in the active state.

In some cases, one or more gap periods 525 may occur between the USIM1 active state operations 520. The gap periods 525 may occur periodically between the USIM1 active state operations 520 in accordance with a gap pattern. For example, a USIM1 active state operation 520 may occur for a duration X, a gap period may occur for a duration Y, another USIM1 active state operation 520 may occur for another duration X, and another gap period may occur for another duration Y, and so on. In some cases, the UE 120 may not be able to perform the USIM1 active state operations 520 (e.g., transmit and receive) during the gap periods 525. However, the UE 120 may use the gap periods 525 to perform one or more functions (e.g., limited functions) associated with the USIM2 510. For example, the UE 120 may use the gap periods 525 to monitor and receive paging, to receive SSBs, and/or to perform idle mode measurements, associated with the USIM2 510.

In some cases, the UE 120 may be configured with two periodic gaps and a single aperiodic gap. For example, the gap period 525 may include (at most) two periodic gaps and one aperiodic gap. Each of the periodic gaps (or aperiodic gaps) may have a duration that is less than or equal to 20 milliseconds (ms). The UE 120 may need to perform a number of activities, such as paging reception or inter-frequency measurements, within these gaps. However, depending on the type of activities and the alignment of the activities that need to be performed, the gap period 525 may either be too short, thereby resulting in not enough time for the activities to be performed, or may be too long, thereby resulting in wasted network resources.

In one example, the gap period 525 (e.g., the periodic gaps within the gap period 525) may be used for performing three activities: measuring a camped cell SSB for a paging duration, receiving PDCCH or PDSCH information, and measuring an SSB for a certain frequency (e.g., a different frequency than the frequency that is currently being used by the UE 120). However, as described above, the gap period 525 may include (at most) two periodic gaps. Thus, the UE 120 may need to perform these three activities using only one or two periodic gaps. In some cases, each of the activities may require between 5 ms-10 ms to be performed. To be able to allocate two periodic gaps among the three activities, the UE 120 may need to request a longer gap duration. Additionally, in some cases, the periodicity of one of the activities may be different than the periodicity of another one of the activities. For example, the SSB monitoring and paging may need to occur in every gap period, whereas inter-frequency measurements may only need to be performed in every other gap period. These limitations may make use of the gap periods 525 inefficient. For example, depending on the location of the inter-frequency SSBs, the UE 120 may need to request up to 20 ms for both periodic gaps, even though the UE 120 may actually require less time than that to perform the above-mentioned activities.

Techniques and apparatuses are described herein for MUSIM gap pattern modification. In some aspects, the UE 120 may obtain a configuration for a first USIM and a configuration for a second USIM. The UE 120 may transmit a request for a modified gap pattern associated with the first USIM or the second USIM. For example, the UE 120 may transmit a request for a gap pattern having a modified gap period duration, a gap pattern having a gap period that includes two or more sub-gap periods, or a request to skip a gap pattern occurrence. The UE 120 may receive an indication of the modified gap pattern, and may selectively communicate or measure according to the modified gap pattern.

As described above, the UE 120 may need to perform a number of activities, such as paging monitoring and reception, SSB reception, and idle mode measurement, within a gap period. However, depending on the type of activities and the alignment of the activities that need to be performed, the gap period may either be too short, thereby resulting in not enough time for the activities to be performed, or may be too long, thereby resulting in wasted network resources. Using the techniques and apparatuses described herein, the UE 120 may request a modified gap pattern that includes a modified gap period duration, one or more sub-gap periods within a gap period, or a skipping of a gap pattern occurrence. Therefore, the likelihood of the gap periods being too short, resulting in not enough time for the activities to be performed, or too long, resulting in wasted network resources, may be reduced.

As indicated above, FIG. 5 is provided as an example. Other examples may differ from what is described with regard to FIG. 5.

FIG. 6 is a diagram illustrating an example 600 for MUSIM gap pattern modification, in accordance with the present disclosure. The UE 120 may communicate with the network node 110.

As shown by reference number 605, the UE 120 may obtain a configuration associated with a first USIM and a configuration associated with a second USIM. In some cases, the first USIM may be associated with a first service provider or a first set of functionalities for the UE 120, and the second USIM may be associated with a second service provider or a second set of functionalities for the UE 120. For example, the UE 120 may use the first USIM for communications using the first service provider or for performing the first set of functionalities, and may use the second USIM for communications using the second service provider or for performing the second set of functionalities.

In some aspects, the UE 120 may activate the first USIM. Thus, the first USIM may be in an active state. Conversely, the second USIM may be considered to be in an idle state or an inactive state. The second USIM may be deactivated by the UE 120, or may default to the idle state or the inactive state based at least in part on the activation of the first USIM. As described above, only one USIM of the MUSIM configuration may be activated at a given time. In some aspects, the UE 120 may be configured to perform one or more active state operations associated with the first USIM while the first USIM is in the active state. For example, the UE 120 may transmit information or data to, and may receive information or data from, the network node 110 using the first USIM while the first USIM is in the active state.

As shown by reference number 610, the UE 120 may transmit, and the network node 110 may receive, a request for a gap pattern associated with the first USIM or the second USIM. In some aspects, the request for the gap pattern may be a request for a modified gap pattern. The request for the modified gap pattern may be a request for an initial gap pattern or may be a request for a modified gap pattern that is associated with the initial gap pattern. The modified gap pattern may be, for example, a modified version of the initial gap pattern. As described in more detail below, the request for the modified gap pattern may be, or may include, a request for a gap pattern having a modified gap period duration, a request for a gap pattern having a gap period that includes two or more sub-gap periods, and/or a request to skip a gap pattern occurrence (e.g., a gap period), among other examples.

In some aspects, the request for the modified gap pattern may be a request for a gap pattern having a modified gap period duration. As described above, a gap period may have a duration that is less than or equal to 20 ms. In some aspects, the request for the modified gap pattern may be a request to shorten the gap period duration or to extend the gap period duration. In this case, each of the (periodic) gap periods may have the shortened gap period duration or the extended gap period duration. In some aspects, the request for the modified gap pattern may be a request for a gap pattern having different gap period durations. For example, the request for the modified gap pattern may be a request for a modified gap period that alternates between 10 ms, Oms, and 20 ms. Thus, the modified gap pattern may have gap periods having durations of 10 ms during a first gap period, Oms (or a skipped gap) during a second gap period, and 20 ms during a third gap period. The alternating gap periods may repeat periodically. For example, the gap periods may repeat periodically as follows: 10 ms, Oms, 20 ms, 10 ms, Oms, 20 ms, etc. In some aspects, each of the alternating gap periods may correspond to one or more activities that are to be performed by the UE 120. For example, the UE 120 may perform SSB camped cell measurements during the first alternating gap period, may not perform any activities during the second alternating gap period, and may perform two or more of the SSB camped cell measurements, PDCCH or PDSCH reception, and SSB measurement for other frequencies during the third alternating gap period.

In some aspects, the request for the modified gap pattern may be a request for one or more sub-gap periods for one or more gap periods associated with the gap pattern. For example, the request for the modified gap pattern may be a request to partition the existing gap period duration into a plurality of sub-gap period durations. In the example that the existing gap period duration is 20 ms, the request for the modified gap pattern may be a request to partition the 20 ms gap period duration into a first 6 ms sub-gap period duration, a second 10 ms sub-gap period duration, and a third 4 ms sub-gap period duration. In some aspects, each of the sub-gap periods may correspond to one or more activities that are to be performed by the UE 120. For example, the UE 120 may be configured to perform one or more activities associated with the second USIM configuration in the first sub-gap period, perform one or more activities associated with the first USIM configuration in the second sub-gap period, and perform one or more activities associated with the second USIM configuration in the third sub-gap period. For example, the UE 120 may perform SSB camped cell measurements for the second USIM configuration during the first sub-gap period and may perform inter-frequency SSB measurements for the second USIM configuration during the third sub-gap period. During the second sub-gap period, the UE 120 may switch to the first USIM configuration for performing one or more activities for the first USIM configuration, and may switch back to the second USIM configuration prior to the start of the third sub-gap period. Although the example above describes a modified gap period having three sub-gap periods, the modified gap period may have any number of sub-gap periods for performing any number of activities.

In some aspects, the request for the modified gap pattern may be a request to skip a gap pattern occurrence (e.g., a gap period). For example, the UE 120 may determine to skip the gap pattern occurrence based at least in part on an indication that there is no paging for the UE 120 (e.g., for a personal equipment identifier (PEI) of the UE 120) or an indication that there is no wake-up signaling (WUS). In another example, the UE 120 may determine to skip the gap pattern occurrence based at least in part on an indication that the UE 120 is at a center of the cell and does not need to perform inter-frequency SSB measurements.

In some aspects, the request for the modified gap pattern may indicate for all gap periods of the gap pattern to be modified. For example, the UE 120 may transmit signaling that indicates for the network node 110 to modify the gap period indefinitely. In some aspects, the request for the modified gap pattern may be a dynamic request that indicates to modify one or more particular gap periods of the gap pattern. For example, the UE 120 may transmit signaling that indicates for the network node 110 to modify the next gap pattern occurrence, or the next one or more gap pattern occurrences, of the gap pattern. After the one or more modified gap pattern occurrences, the gap pattern may return to a previous gap pattern configuration or switch to another gap pattern configuration. In some aspects, the signaling may be Layer 1 signaling, Layer 2 signaling, or Layer 3 signaling. For example, the UE 120 may transmit UCI, a medium access control (MAC) control element (CE) (MAC-CE), or an RRC message that includes the indication of the modified gap pattern.

In some aspects, the request for the modified gap pattern may include a combination of the above requests. For example, the request for the modified gap pattern may include two or more of: the request for the gap pattern having the modified gap period duration, the request for the gap pattern having the gap period that includes the two or more sub-gap periods, or the request to skip the gap pattern occurrence. In some aspects, the request may indicate for two or more of the modifications to occur in the same gap period occurrence. For example, the request may indicate for the network node 110 modify (e.g., extend) the duration the duration of the gap periods for the gap pattern, and to partition the extended gap periods into a plurality of sub-gap periods. In some aspects, the request may indicate that one or more of the modifications should occur for some of the gap period occurrences, and that one or more other of the modifications should occur for other of the gap period occurrences. For example, the request may indicate that all of the gap periods for the gap pattern should be extended, but that every other gap period for the gap pattern should be partitioned into the plurality of sub-gap periods.

In some aspects, the request for the modified gap pattern may be based at least in part on a carrier aggregation mode of the UE 120, a dual connectivity mode of the UE 120, or a frequency band that is being used by the UE 120. For example, the UE 120 may transmit a first type of modified gap pattern request based at least in part on the UE 120 using a first carrier aggregation mode, or may transmit a second type of modified gap pattern request (or may not transmit a modified gap pattern request) based at least in part on the UE 120 using a second carrier aggregation mode. In another example, the UE 120 may transmit a first type of modified gap pattern request based at least in part on the UE 120 using a first dual connectivity mode (e.g., using a master node (MN)), or may transmit a second type of modified gap pattern request (or may not transmit a modified gap pattern request) based at least in part on the UE 120 using a second dual connectivity mode (e.g., using a secondary node (SN)). In another example, the UE 120 may transmit a first type of modified gap pattern request based at least in part on the UE 120 using a first frequency band (e.g., FR1), or may transmit a second type of modified gap pattern request (or may not transmit a modified gap pattern request) based at least in part on the UE 120 using a second frequency band (e.g., FR2).

As shown by reference number 615, the network node 110 may transmit, and the UE 120 may receive, an indication of the modified gap pattern. For example, the network node 110 may transmit an indication that the UE 120 may use the requested modified gap pattern. In some aspects, the indication of the modified gap pattern may include a modified gap pattern configuration. The modified gap pattern configuration may correspond to the requested modified gap pattern or may be based at least in part on the requested modified gap pattern.

In some aspects, the modified gap pattern may be activated or deactivated by the UE 120 or the network node 110. For example, the UE 120 may activate the modified gap pattern based at least in part on receiving the indication of the modified gap pattern, and may deactivate the modified gap pattern based at least in part on determining to use another modified gap pattern. Additionally, or alternatively, the network node 110 may activate the modified gap pattern based at least in part on transmitting the indication of the modified gap pattern, and may deactivate the modified gap pattern based at least in part on determining to use another modified gap pattern or receiving an indication that another modified gap pattern is to be used. In some aspects, activating or deactivating of the modified gap pattern may include activating a gap pattern of a plurality of configured gap patterns, and deactivating another gap pattern of the plurality of configured gap patterns. In some aspects, the UE 120 and/or the network node 110 may be configured to switch between a plurality of gap patterns. For example, the UE 120 and/or the network node 110 may switch from the modified gap pattern to another modified gap pattern or to a previously configured gap pattern. In some aspects, the UE 120 and/or the network node 110 may use Layer 1 signaling, Layer 2 signaling, or Layer 3 signaling to activate, deactivate, and/or switch between the plurality of gap pattern configurations. For example, the UE 120 may transmit UCI, a MAC-CE, or an RRC message that indicates to activate, deactivate, and/or switch between the plurality of gap pattern configurations. Additionally, or alternatively, the network node 110 may transmit DCI, a MAC-CE, or an RRC message that indicates to activate, deactivate, and/or switch between the plurality of gap pattern configurations.

As shown by reference number 620, the UE 120 may selectively communicate or measure according to the modified gap pattern. As described above, the UE 120 may be configured to perform one or more active state operations (e.g., transmit or receive) associated with the first USIM configuration while the first USIM configuration is in an active state. Additionally, or alternatively, the UE 120 may be configured to perform one or more other functions associated with the second USIM configuration during the gap periods while the second USIM configuration is in an idle state or an inactive state. For example, the UE 120 may be configured to measure a camped cell SSB for a paging duration, receive PDCCH or PDSCH information, and/or measure an SSB for a different frequency than is currently being used, among other examples, for the second USIM configuration and during the gap periods of the modified gap pattern. In some aspects, the UE 120 may be configured to perform (or not perform) one or more of the above activities during an extended gap period of the modified gap pattern, a shortened gap period of the modified gap pattern, and/or during one or more sub-gap periods of the modified gap pattern. Alternatively, the UE 120 may be configured not to perform any of the above activities during a skipped gap pattern occurrence (e.g., a skipped gap period of the modified gap pattern).

As described above, depending on the type of activities and the alignment of the activities that need to be performed, a gap period may either be too short, thereby resulting in not enough time for the activities to be performed, or may be too long, thereby resulting in wasted network resources. Using the techniques and apparatuses described herein, the UE 120 may request a modified gap pattern that includes a modified gap period duration, one or more sub-gap periods within a gap period, or a skipping of a gap pattern occurrence. Therefore, the likelihood of the gap periods being too short, resulting in not enough time for the activities to be performed, or too long, resulting in wasted network resources, may be reduced.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with MUSIM gap pattern modification.

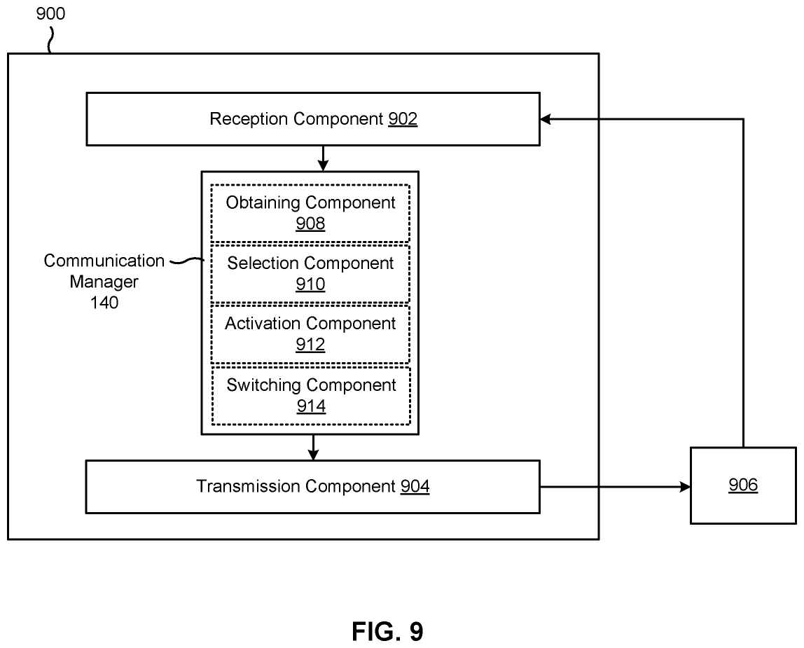

As shown in FIG. 7, in some aspects, process 700 may include obtaining a configuration associated with a first USIM and a configuration associated with a second USIM (block 710). For example, the UE (e.g., using communication manager 140 and/or obtaining component 908, depicted in FIG. 9) may obtain a configuration associated with a first USIM and a configuration associated with a second USIM, as described above.

As further shown in FIG. 7, in some aspects, process 700 may include transmitting a request for a gap pattern associated with the first USIM or the second USIM (block 720). For example, the UE (e.g., using communication manager 140 and/or transmission component 904, depicted in FIG. 9) may transmit a request for a gap pattern associated with the first USIM or the second USIM, as described above.

As further shown in FIG. 7, in some aspects, process 700 may include receiving an indication of the gap pattern (block 730). For example, the UE (e.g., using communication manager 140 and/or reception component 902, depicted in FIG. 9) may receive an indication of the gap pattern, as described above.

As further shown in FIG. 7, in some aspects, process 700 may include selectively communicating or measuring according to the gap pattern (block 740). For example, the UE (e.g., using communication manager 140 and/or selection component 910, depicted in FIG. 9) may selectively communicate or measure according to the gap pattern, as described above.

Process 700 may include additional aspects, such as any single aspect or any combination of aspects described below and/or in connection with one or more other processes described elsewhere herein.

In a first aspect, transmitting the request for the gap pattern comprises transmitting the request for the gap pattern associated with the first USIM, and wherein selectively communicating or measuring comprises selectively communicating or measuring according to the gap pattern and using the second USIM.

In a second aspect, alone or in combination with the first aspect, selectively communicating or measuring according to the gap pattern comprises measuring a camped cell SSB for paging reception, receiving physical downlink control channel information or physical downlink shared channel information, or measuring an SSB associated with a certain frequency.

In a third aspect, alone or in combination with one or more of the first and second aspects, transmitting the request for the gap pattern comprises transmitting a request for two or more alternating gap period durations.

In a fourth aspect, alone or in combination with one or more of the first through third aspects, transmitting the request for the gap pattern comprises transmitting a request for a gap period having a modified duration.

In a fifth aspect, alone or in combination with one or more of the first through fourth aspects, transmitting the request for the gap pattern comprises transmitting a request for a plurality of sub-gap periods for a period associated with the gap pattern.

In a sixth aspect, alone or in combination with one or more of the first through fifth aspects, selectively communicating or measuring according to the gap pattern comprises communicating or measuring during a first sub-gap period of the plurality of sub-gap periods, not communicating or measuring during a second sub-gap period of the plurality of sub-gap periods, and communicating or measuring during a third sub-gap period of the plurality of sub-gap periods.

In a seventh aspect, alone or in combination with one or more of the first through sixth aspects, transmitting the request for the gap pattern comprises transmitting a request to skip one or more gap pattern occurrences.

In an eighth aspect, alone or in combination with one or more of the first through seventh aspects, transmitting the request for the gap pattern comprises transmitting uplink control information, a medium access control message, or a radio resource control message that includes an indication of the request for the gap pattern.

In a ninth aspect, alone or in combination with one or more of the first through eighth aspects, transmitting the request for the gap pattern comprises transmitting the request for the gap pattern based at least in part on a carrier aggregation mode of the UE, a dual connectivity mode of the UE, or a frequency band that is being used by the UE.

In a tenth aspect, alone or in combination with one or more of the first through ninth aspects, transmitting the request for the gap pattern comprises transmitting a request for a plurality of gap patterns, and wherein receiving the indication of the gap pattern comprises receiving an indication of one or more gap patterns of the plurality of gap patterns.

In an eleventh aspect, alone or in combination with one or more of the first through tenth aspects, process 700 includes activating or deactivating a select gap pattern of the one or more gap patterns.

In a twelfth aspect, alone or in combination with one or more of the first through eleventh aspects, process 700 includes switching between a first gap pattern of the one or more gap patterns and a second gap pattern of the one or more gap patterns.

In a thirteenth aspect, alone or in combination with one or more of the first through twelfth aspects, the gap pattern includes at least one periodic gap period.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with MUSIM gap pattern modification.

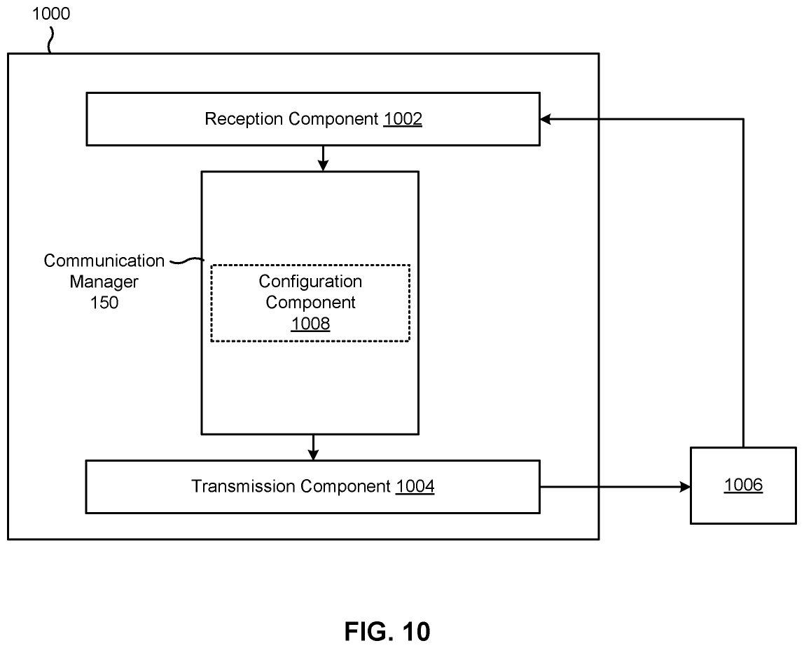

As shown in FIG. 8, in some aspects, process 800 may include transmitting, to a UE, a configuration associated with a first USIM and a configuration associated with a second USIM (block 810). For example, the network node (e.g., using communication manager 150 and/or transmission component 1004, depicted in FIG. 10) may transmit, to a UE, a configuration associated with a first USIM and a configuration associated with a second USIM, as described above.

As further shown in FIG. 8, in some aspects, process 800 may include receiving, from the UE, a request for a gap pattern associated with the first USIM or the second USIM (block 820). For example, the network node (e.g., using communication manager 150 and/or reception component 1002, depicted in FIG. 10) may receive, from the UE, a request for a gap pattern associated with the first USIM or the second USIM, as described above.

As further shown in FIG. 8, in some aspects, process 800 may include transmitting, to the UE, an indication of the gap pattern (block 830). For example, the network node (e.g., using communication manager 150 and/or transmission component 1004, depicted in FIG. 10) may transmit, to the UE, an indication of the gap pattern, as described above.

Process 800 may include additional aspects, such as any single aspect or any combination of aspects described below and/or in connection with one or more other processes described elsewhere herein.

In a first aspect, the request for the gap pattern comprises a request for two or more alternating gap period durations, and wherein the indication of the gap pattern comprises an indication of the two or more alternating gap period durations.

In a second aspect, alone or in combination with the first aspect, the request for the gap pattern comprises a request for a gap period having a modified duration, and wherein the indication of the gap pattern comprises an indication of the gap period having the modified duration.

In a third aspect, alone or in combination with one or more of the first and second aspects, the request for the gap pattern comprises a request for a plurality of sub-gap periods for a period associated with the gap pattern, and wherein the indication of the gap pattern comprises an indication of the plurality of sub-gap periods for the period associated with the gap pattern.

In a fourth aspect, alone or in combination with one or more of the first through third aspects, the request for the gap pattern comprises a request to skip one or more gap pattern occurrences, and wherein the indication of the gap pattern comprises an indication to skip the one or more gap pattern occurrences.

In a fifth aspect, alone or in combination with one or more of the first through fourth aspects, receiving the request for the gap pattern comprises receiving uplink control information, a medium access control message, or a radio resource control message that includes an indication of the request for the gap pattern.

In a sixth aspect, alone or in combination with one or more of the first through fifth aspects, process 800 includes transmitting downlink control information, a medium access control message, or a radio resource control message associated with confirming the gap pattern, activating the gap pattern, or deactivating the gap pattern.

In a seventh aspect, alone or in combination with one or more of the first through sixth aspects, the request for the gap pattern comprises a request for a plurality of gap patterns, and wherein the indication of the gap pattern comprises an indication of one or more gap patterns of the plurality of gap patterns.

In an eighth aspect, alone or in combination with one or more of the first through seventh aspects, process 800 includes receiving an indication that a select gap pattern of the one or more gap patterns has been activated or deactivated.

In a ninth aspect, alone or in combination with one or more of the first through eighth aspects, process 800 includes receiving an indication of a switching between a first gap pattern of the one or more gap patterns and a second gap pattern of the one or more gap patterns.

In a tenth aspect, alone or in combination with one or more of the first through ninth aspects, the gap pattern includes at least one periodic gap period.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an obtaining component 908, a selection component 910, an activation component 912, or a switching component 914, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The obtaining component 908 may obtain a configuration associated with a first USIM and a configuration associated with a second USIM. The transmission component 904 may transmit a request for a gap pattern associated with the first USIM or the second USIM. The reception component 902 may receive an indication of the gap pattern. The selection component 910 may selectively communicate or measure according to the gap pattern.

The activation component 912 may activate or deactivating a select gap pattern of the one or more gap patterns.

The switching component 914 may switch between a first gap pattern of the one or more gap patterns and a second gap pattern of the one or more gap patterns.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a configuration component 1008, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The configuration component 1008 may obtain a configuration associated with a first USIM and a configuration associated with a second USIM. The transmission component 1004 may transmit, to a UE, a configuration associated with a first USIM and a configuration associated with a second USIM. The reception component 1002 may receive, from the UE, a request for a gap pattern associated with the first USIM or the second USIM. The transmission component 1004 may transmit, to the UE, an indication of the gap pattern.

The transmission component 1004 may transmit downlink control information, a medium access control message, or a radio resource control message associated with confirming the gap pattern, activating the gap pattern, or deactivating the gap pattern.

The reception component 1002 may receive an indication that a select gap pattern of the one or more gap patterns has been activated or deactivated. The reception component 1002 may receive an indication of a switching between a first gap pattern of the one or more gap patterns and a second gap pattern of the one or more gap patterns.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: obtaining a configuration associated with a first universal subscriber identity module (USIM) and a configuration associated with a second USIM; transmitting a request for a gap pattern associated with the first USIM or the second USIM; receiving an indication of the gap pattern; and selectively communicating or measuring according to the gap pattern.

Aspect 2: The method of Aspect 1, wherein transmitting the request for the gap pattern comprises transmitting a request for an initial gap pattern or transmitting a request for a modified gap pattern that is associated with the initial gap pattern.

Aspect 3: The method of any of Aspects 1-2, wherein transmitting the request for the gap pattern comprises transmitting the request for the gap pattern associated with the first USIM, and wherein selectively communicating or measuring comprises selectively communicating or measuring according to the gap pattern and using the second USIM.

Aspect 4: The method of Aspect 3, wherein, during the gap pattern associated with the first USIM, the first USIM is in a connected state and the second USIM is in an idle state or an inactive state.

Aspect 5: The method of any of Aspects 1-4, wherein selectively communicating or measuring according to the gap pattern comprises measuring a camped cell synchronization signal block (SSB) for paging reception, receiving physical downlink control channel information or physical downlink shared channel information, or measuring an SSB associated with a certain frequency.

Aspect 6: The method of any of Aspects 1-5, wherein transmitting the request for the gap pattern comprises transmitting a request for two or more alternating gap period durations.

Aspect 7: The method of any of Aspects 1-6, wherein transmitting the request for the gap pattern comprises transmitting a request for a gap period having a modified duration.

Aspect 8: The method of any of Aspects 1-7, wherein transmitting the request for the gap pattern comprises transmitting a request for a plurality of sub-gap periods for a period associated with the gap pattern.

Aspect 9: The method of Aspect 8, wherein selectively communicating or measuring according to the gap pattern comprises communicating or measuring during a first sub-gap period of the plurality of sub-gap periods, not communicating or measuring during a second sub-gap period of the plurality of sub-gap periods, and communicating or measuring during a third sub-gap period of the plurality of sub-gap periods.

Aspect 10: The method of any of Aspects 1-9, wherein transmitting the request for the gap pattern comprises transmitting a request to skip one or more gap pattern occurrences.

Aspect 11: The method of any of Aspects 1-10, wherein transmitting the request for the gap pattern comprises transmitting uplink control information, a medium access control message, or a radio resource control message that includes an indication of the request for the gap pattern.

Aspect 12: The method of any of Aspects 1-11, wherein transmitting the request for the gap pattern comprises transmitting the request for the gap pattern based at least in part on a carrier aggregation mode of the UE, a dual connectivity mode of the UE, or a frequency band that is being used by the UE.

Aspect 13: The method of any of Aspects 1-12, wherein transmitting the request for the gap pattern comprises transmitting a request for a plurality of gap patterns, and wherein receiving the indication of the gap pattern comprises receiving an indication of one or more gap patterns of the plurality of gap patterns.

Aspect 14: The method of Aspect 13, further comprising activating or deactivating a select gap pattern of the one or more gap patterns.

Aspect 15: The method of Aspect 13, further comprising switching between a first gap pattern of the one or more gap patterns and a second gap pattern of the one or more gap patterns.

Aspect 16: The method of any of Aspects 1-15, wherein the gap pattern includes at least one periodic gap period.

Aspect 17: A method of wireless communication performed by a network node, comprising: transmitting, to a user equipment (UE), a configuration associated with a first universal subscriber identity module (USIM) and a configuration associated with a second USIM; receiving, from the UE, a request for a gap pattern associated with the first USIM or the second USIM; and transmitting, to the UE, an indication of the gap pattern.

Aspect 18: The method of Aspect 17, wherein receiving the request for the gap pattern comprises receiving a request for an initial gap pattern or receiving a request for a modified gap pattern that is associated with the initial gap pattern.

Aspect 19: The method of any of Aspects 17-18, wherein the request for the gap pattern comprises a request for two or more alternating gap period durations, and wherein the indication of the gap pattern comprises an indication of the two or more alternating gap period durations.

Aspect 20: The method of any of Aspects 17-19, wherein the request for the gap pattern comprises a request for a gap period having a modified duration, and wherein the indication of the gap pattern comprises an indication of the gap period having the modified duration.

Aspect 21: The method of any of Aspects 17-20, wherein the request for the gap pattern comprises a request for a plurality of sub-gap periods for a period associated with the gap pattern, and wherein the indication of the gap pattern comprises an indication of the plurality of sub-gap periods for the period associated with the gap pattern.

Aspect 22: The method of any of Aspects 17-21, wherein the request for the gap pattern comprises a request to skip one or more gap pattern occurrences, and wherein the indication of the gap pattern comprises an indication to skip the one or more gap pattern occurrences.

Aspect 23: The method of any of Aspects 17-22, wherein receiving the request for the gap pattern comprises receiving uplink control information, a medium access control message, or a radio resource control message that includes an indication of the request for the gap pattern.

Aspect 24: The method of any of Aspects 17-23, further comprising transmitting downlink control information, a medium access control message, or a radio resource control message associated with confirming the gap pattern, activating the gap pattern, or deactivating the gap pattern.

Aspect 25: The method of any of Aspects 17-24, wherein the request for the gap pattern comprises a request for a plurality of gap patterns, and wherein the indication of the gap pattern comprises an indication of one or more gap patterns of the plurality of gap patterns.

Aspect 26: The method of Aspect 25, further comprising receiving an indication that a select gap pattern of the one or more gap patterns has been activated or deactivated.

Aspect 27: The method of Aspect 25, further comprising receiving an indication of a switching between a first gap pattern of the one or more gap patterns and a second gap pattern of the one or more gap patterns.

Aspect 28: The method of any of Aspects 17-27, wherein the gap pattern includes at least one periodic gap period.

Aspect 29: An apparatus for wireless communication at a device, comprising a processor; memory coupled with the processor; and instructions stored in the memory and executable by the processor to cause the apparatus to perform the method of one or more of Aspects 1-16.

Aspect 30: A device for wireless communication, comprising a memory and one or more processors coupled to the memory, the one or more processors configured to perform the method of one or more of Aspects 1-16.

Aspect 31: An apparatus for wireless communication, comprising at least one means for performing the method of one or more of Aspects 1-16.

Aspect 32: A non-transitory computer-readable medium storing code for wireless communication, the code comprising instructions executable by a processor to perform the method of one or more of Aspects 1-16.

Aspect 33: A non-transitory computer-readable medium storing a set of instructions for wireless communication, the set of instructions comprising one or more instructions that, when executed by one or more processors of a device, cause the device to perform the method of one or more of Aspects 1-16.

Aspect 34: An apparatus for wireless communication at a device, comprising a processor; memory coupled with the processor; and instructions stored in the memory and executable by the processor to cause the apparatus to perform the method of one or more of Aspects 17-28.

Aspect 35: A device for wireless communication, comprising a memory and one or more processors coupled to the memory, the one or more processors configured to perform the method of one or more of Aspects 17-28.

Aspect 36: An apparatus for wireless communication, comprising at least one means for performing the method of one or more of Aspects 17-28.

Aspect 37: A non-transitory computer-readable medium storing code for wireless communication, the code comprising instructions executable by a processor to perform the method of one or more of Aspects 17-28.

Aspect 38: A non-transitory computer-readable medium storing a set of instructions for wireless communication, the set of instructions comprising one or more instructions that, when executed by one or more processors of a device, cause the device to perform the method of one or more of Aspects 17-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
obtain a configuration associated with a first universal subscriber identity module (USIM) and a configuration associated with a second USIM;
transmit a request for a gap pattern associated with the first USIM or the second USIM;
receive an indication of the gap pattern; and
selectively communicate or measuring according to the gap pattern.

2. The apparatus of claim 1, wherein the one or more processors, to transmit the request for the gap pattern, are configured to transmit a request for an initial gap pattern or to transmit a request for a modified gap pattern that is associated with the initial gap pattern.

3. The apparatus of claim 1, wherein the one or more processors, to transmit the request for the gap pattern, are configured to transmit a request for a gap pattern associated with the first USIM, and wherein the one or more processors, to selectively communicate or measure, are configured to selectively communicate or measure according to the gap pattern and using the second USIM.

4. The apparatus of claim 3, wherein, during the gap pattern associated with the first USIM, the first USIM is in a connected state and the second USIM is in an idle state or an inactive state.

5. The apparatus of claim 1, wherein the one or more processors, to selectively communicate or measure according to the gap pattern, are configured to measure a camped cell synchronization signal block (SSB) for paging reception, receive physical downlink control channel information or physical downlink shared channel information, or measure an SSB associated with a certain frequency.

6. The apparatus of claim 1, wherein the one or more processors, to transmit the request for the gap pattern, are configured to transmit a request for two or more alternating gap period durations.

7. The apparatus of claim 1, wherein the one or more processors, to transmit the request for the gap pattern, are configured to transmit a request for a gap period having a modified duration.

8. The apparatus of claim 1, wherein the one or more processors, to transmit the request for the gap pattern, are configured to transmit a request for a plurality of sub-gap periods for a period associated with the gap pattern.

9. The apparatus of claim 8, wherein the one or more processors, to selectively communicate or measure according to the gap pattern, are configured to communicate or measuring during a first sub-gap period of the plurality of sub-gap periods, not communicating or measuring during a second sub-gap period of the plurality of sub-gap periods, and communicating or measuring during a third sub-gap period of the plurality of sub-gap periods.

10. The apparatus of claim 1, wherein the one or more processors, to transmit the request for the gap pattern, are configured to transmit a request to skip one or more gap pattern occurrences.

11. The apparatus of claim 1, wherein the one or more processors, to transmit the request for the gap pattern, are configured to transmit uplink control information, a medium access control message, or a radio resource control message that includes an indication of the request for the gap pattern.

12. The apparatus of claim 1, wherein the one or more processors, to transmit the request for the gap pattern, are configured to transmit the request for the gap pattern based at least in part on a carrier aggregation mode of the UE, a dual connectivity mode of the UE, or a frequency band that is being used by the UE.

13. The apparatus of claim 1, wherein the one or more processors, to transmit the request for the gap pattern, are configured to transmit a request for a plurality of gap patterns, and wherein the one or more processors, to receive the indication of the gap pattern, are configured to receive an indication of one or more gap patterns of the plurality of gap patterns.

14. The apparatus of claim 13, wherein the one or more processors are further configured to activate or deactivating a select gap pattern of the one or more gap patterns.

15. The apparatus of claim 13, wherein the one or more processors are further configured to switch between a first gap pattern of the one or more gap patterns and a second gap pattern of the one or more gap patterns.

16. The apparatus of claim 1, wherein the gap pattern includes at least one periodic gap period.

17. An apparatus for wireless communication at a network node, comprising:
a memory; and
one or more processors, coupled to the memory, configured to:
transmit, to a user equipment (UE), a configuration associated with a first universal subscriber identity module (USIM) and a configuration associated with a second USIM;
receive, from the UE, a request for a gap pattern associated with the first USIM or the second USIM; and
transmit, to the UE, an indication of the gap pattern.

18. The apparatus of claim 17, wherein the one or more processors, to receive the request for the gap pattern, are configured to receive a request for an initial gap pattern or to receive a request for a modified gap pattern that is associated with the initial gap pattern.

19. The apparatus of claim 17, wherein the request for the gap pattern comprises a request for two or more alternating gap period durations, and wherein the indication of the gap pattern comprises an indication of the two or more alternating gap period durations.

20. The apparatus of claim 17, wherein the request for the gap pattern comprises a request for a gap period having a modified duration, and wherein the indication of the gap pattern comprises an indication of the gap period having the modified duration.

21. The apparatus of claim 17, wherein the request for the gap pattern comprises a request for a plurality of sub-gap periods for a period associated with the gap pattern, and wherein the indication of the gap pattern comprises an indication of the plurality of sub-gap periods for the period associated with the gap pattern.

22. The apparatus of claim 17, wherein the request for the gap pattern comprises a request to skip one or more gap pattern occurrences, and wherein the indication of the gap pattern comprises an indication to skip the one or more gap pattern occurrences.

23. The apparatus of claim 17, wherein the one or more processors, to receive the request for the gap pattern, are configured to receive uplink control information, a medium access control message, or a radio resource control message that includes an indication of the request for the gap pattern.

24. The apparatus of claim 17, wherein the one or more processors are further configured to transmit downlink control information, a medium access control message, or a radio resource control message associated with confirming the gap pattern, activating the gap pattern, or deactivating the gap pattern.

25. The apparatus of claim 17, wherein the request for the gap pattern comprises a request for a plurality of gap patterns, and wherein the indication of the gap pattern comprises an indication of one or more gap patterns of the plurality of gap patterns.

26. The apparatus of claim 25, wherein the one or more processors are further configured to receive an indication that a select gap pattern of the one or more gap patterns has been activated or deactivated.

27. The apparatus of claim 25, wherein the one or more processors are further configured to receive an indication of a switching between a first gap pattern of the one or more gap patterns and a second gap pattern of the one or more gap patterns.

28. The apparatus of claim 17, wherein the gap pattern includes at least one periodic gap period.

29. A method of wireless communication performed by a user equipment (UE), comprising:
obtaining a configuration associated with a first universal subscriber identity module (USIM) and a configuration associated with a second USIM;
transmitting a request for a gap pattern associated with the first USIM or the second USIM;
receiving an indication of the gap pattern; and
selectively communicating or measuring according to the gap pattern.

30. A method of wireless communication performed by a network node, comprising:
transmitting, to a user equipment (UE), a configuration associated with a first universal subscriber identity module (USIM) and a configuration associated with a second USIM;
receiving, from the UE, a request for a gap pattern associated with the first USIM or the second USIM; and
transmitting, to the UE, an indication of the gap pattern.
